(19) United States
(12) Patent Application Publication
(10) Pub. No.: US 2018/0041046 A1
(43) Pub. Date: Feb. 8, 2018

(54) MULTI-POWER SUPPLY DEVICE

(71) Applicant: NATIONAL CHUNG SHAN INSTITUTE OF SCIENCE AND TECHNOLOGY, TAOYUAN CITY (TW)

(72) Inventors: KAI-YUAN FU, TAOYUAN CITY (TW); RUH-HUA WU, TAOYUAN CITY (TW); CHUNG-TSENG CHANG, TAOYUAN CITY (TW)

(21) Appl. No.: 15/228,688

(22) Filed: Aug. 4, 2016

(51) Int. Cl. H02J 5/00; H02J 9/06; H02M 1/08; H02M 7/04; H02M 7/44

(52) U.S. Cl. CPC H02J 5/00; H02M 7/04; H02M 7/44; H02M 1/08; H02J 9/061; H02M 2001/0009

(57) ABSTRACT

A multi-power supply device includes a plurality of power input units configured to each supply an input power and being DC power input units, AC power input units, or a combination thereof; power channel control units electrically connected to the power input units, respectively, and turned on as soon as the output end voltage of the power channel control units is lower than the input end voltage of the power channel control units, wherein the power channel control unit with the highest input voltage is turned on to output an ON voltage; and a power output unit electrically connected to the power channel control units and adapted to output the ON voltage.

### FIELD OF THE INVENTION

The present invention relates to power supply devices and, more particularly, to a multi-power supply device.

### BACKGROUND OF THE INVENTION

Power supply devices are so important to power-driven appliances that the latter cannot work without the former. In this regard, the stability of power supply and the availability of backup power are of vital importance. One of the features of the power supply to conventional electric appliances operating at a low current is: switching automatically between a built-in battery and an external power source (usually a USB-enabled +5V power source) by an autoswitching power mux, thereby allowing the electric appliances to continue to function as soon as interruption of power supply from the external power source happens. However, the backup power, which is limited to less than several watts, provides a current that is too low to meet the general power requirements of electric appliances. Although a conventional electric appliance is typically equipped with an emergency power system, such as an uninterruptible power supply (UPS) or a standby generator, to cope with a power outage, both the uninterruptible power supply (UPS) and the standby generator take time to switch from the external power source to the battery and undergo abrupt voltage changes during the switching process to the detriment of the service life of the electric appliance. Furthermore, the backup power will be supplied only if a power outage happens, and in consequence the emergency power system will age and even fail insidiously after years of idling, thereby undermining its reliability.

Power outages are tolerable to households but prove terribly fatal to life-sustaining medical devices operating at the hospital, greenhouses, nuclear plants, aircrafts, etc. Therefore, it is necessary for the industrial sector to develop a multi-power supply device composed of multiple power sources that coexist in a normal state and enable seamless connectivity in an emergency.

### SUMMARY OF THE INVENTION

In view of the aforesaid drawbacks of the prior art, it is an objective of the present invention to provide a multi-power supply device composed of multiple power sources that coexist, strike a balance between each other automatically, and operate independently of each other in a normal state but effectuate seamless connectivity with backup power as soon as main power vanishes.

In order to achieve the above and other objectives, the present invention provides a multi-power supply device, comprising: a plurality of power input units configured to each supply an input power and being DC power input units, AC power input units, or a combination thereof; a plurality of power channel control units electrically connected to the power input units, respectively, and turned on as soon as an output end voltage of the power channel control units is lower than an input end voltage of the power channel control units, wherein the power channel control unit of a highest input voltage is turned on to generate an ON voltage; and a power output unit electrically connected to the power channel control units and adapted to output the ON voltage.

Regarding the multi-power supply device, in an embodiment, the multi-power supply device further comprises an AC-to-DC conversion unit electrically connected between each said AC power input unit and a corresponding one of the power channel control units to convert AC power output from the AC-to-DC conversion unit into DC power.

Regarding the multi-power supply device, in an embodiment, the power input units comprise at least a DC power input unit and at least an AC power input unit.

Regarding the multi-power supply device, in an embodiment, the multi-power supply device further comprises an AC-to-DC conversion unit electrically connected between each said AC power input unit and a corresponding one of the power channel control units to convert AC power output from the AC-to-DC conversion unit into DC power.

Regarding the multi-power supply device, in an embodiment, the power channel control units are power diodes.

Regarding the multi-power supply device, in an embodiment, the multi-power supply device further comprises power monitoring units electrically connected between the power channel control units and the power output unit, respectively, to monitor voltage and current and send a monitoring signal.

Regarding the multi-power supply device, in an embodiment, the multi-power supply device further comprises a signal processing unit electrically connected to the power monitoring units to receive the monitoring signal from the power monitoring units, so as to send an alert in response to a change in the monitoring signal from the power monitoring units.

Regarding the multi-power supply device, in an embodiment, the power monitoring units comprise a current sensing chip and a voltage detecting loop.

Regarding the multi-power supply device, in an embodiment, the multi-power supply device further comprises a DC-to-AC conversion unit electrically connected to the power output unit to convert DC power output from the power output unit into AC power output.

The present invention has advantages as follows: multiple power sources coexist; every power source status is monitored; a balance is struck between the power sources automatically; the power sources operate independently of each other; if the main power vanishes, a backup power will prevail seamlessly; voltage fluctuations which might otherwise occur as a result of the switching of a switch are precluded; and a monitoring unit detects power changes.

The summary above the description below explain the means and measures taken to achieve a predetermined objective of the present invention and the effects of the present invention. The other objectives and advantages of the present invention are described hereunder.

### BRIEF DESCRIPTION OF THE DRAWINGS

FIG. 1 is a schematic view of a multi-power supply device according to an embodiment of the present invention;

FIG. 2 is a schematic view of the multi-power supply device capable of AC to DC conversion according to an embodiment of the present invention;

FIG. 3 is a schematic view of the multi-power supply device capable of power monitoring according to an embodiment of the present invention;

FIG. 4 is a schematic view of the multi-power supply device capable of signal processing according to an embodiment of the present invention; and

FIG. 5 is a schematic view of the multi-power supply device capable of DC to AC conversion according to an embodiment of the present invention.

### DETAILED DESCRIPTION OF THE PREFERRED EMBODIMENTS

The implementation of the present invention is hereunder illustrated with specific embodiments. Persons skilled in the art can easily understand the other advantages and effects of the present invention by referring to the disclosure contained in the specification.

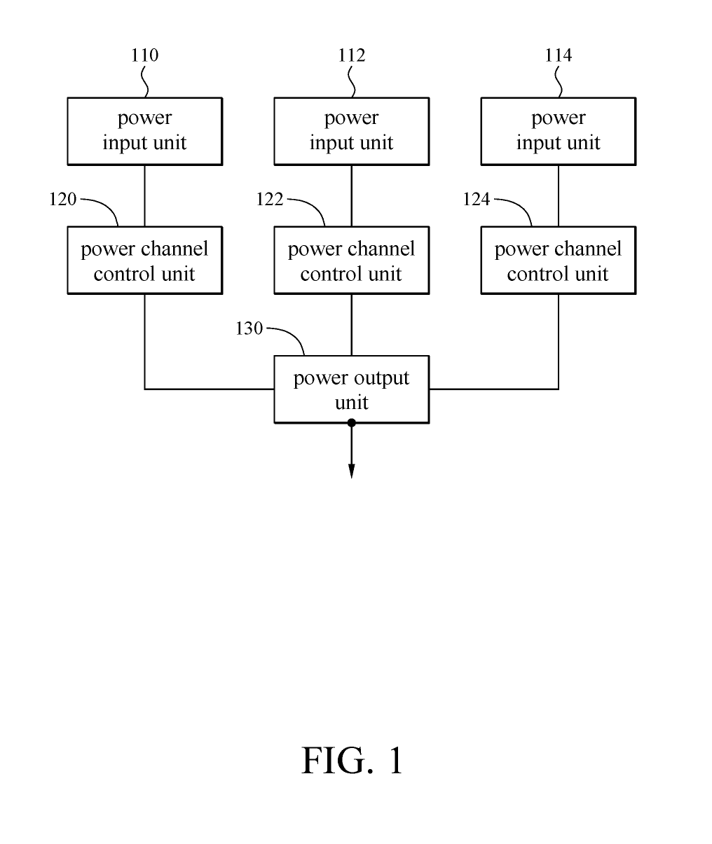

Referring to FIG. 1, there is shown a multi-power supply device according to an embodiment of the present invention. As shown in the diagram, a multi-power supply device according to an embodiment of the present invention comprises a plurality of power input units (110, 112, 114), a plurality of power channel control units (120, 122, 124), and a power output unit (130).

The power input units (110, 112, 114) are configured to each supply an input power. The power input units (110, 112, 114) are DC power input units (for generating DC power, such as DC voltage or DC current), are AC power input units (for generating AC power, such as AC voltage or AC power), or are partly DC power input units (for generating DC power, such as DC voltage or DC current) and partly AC power input units (for generating AC power, such as AC voltage or AC power.) In an embodiment of the present invention, the power input units (110, 112) are AC power input units, whereas the power input units (114) are DC power input units, with the power input units (110, 112, 114) being voltage sources, and input power being voltage. However, in a variant embodiment, the power input units (110, 112, 114) are current sources.

The power channel control units (120, 122, 124) are electrically connected to the power input units (110, 112, 114), respectively. The power channel control units (120, 122, 124) are characterized in that each are turned on as soon as its output end is of a higher voltage than its input end, wherein, among the power channel control units (120, 122, 124), the power channel control unit with the largest input power (i.e., the highest input voltage) is turned on to generate an ON voltage. In an embodiment of the present invention, the power channel control units (120, 122, 124) are power diodes which not only prevent voltage from tracing back to the other power input end but also prevent an external battery from being overly charged.

The power output unit (130) is electrically connected to the power channel control units (120, 122, 124) and generates an ON voltage (i.e., the highest output voltage.)

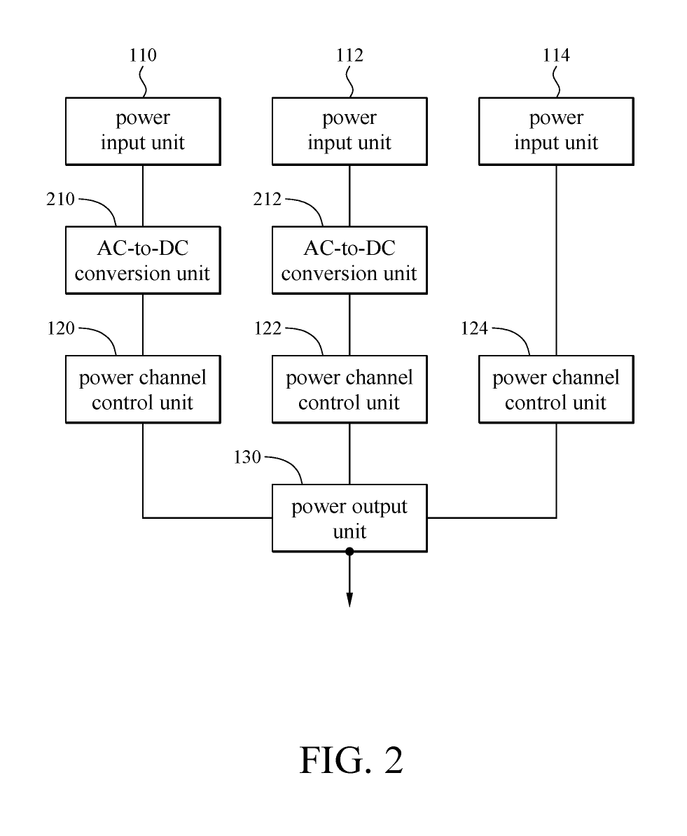

Referring to FIG. 2, there is shown a schematic view of the multi-power supply device capable of AC to DC conversion according to an embodiment of the present invention. In an embodiment of the present invention, the multi-power supply device further comprises a plurality of AC-to-DC conversion units (210, 212) electrically connected between the power input units (110, 112) and the power channel control units (120, 122), respectively, and adapted to convert AC power into DC power. In an embodiment of the present invention, power input unit (110) supplies utility power at an AC voltage of 110V which is converted by the AC-to-DC conversion unit (210) into a DC voltage of 13V, whereas the power input unit (112) is a power generator which supplies an AC voltage of 110V which is converted by the AC-to-DC conversion unit (212) into a DC voltage of 12V, wherein the power input unit (114) is a storage battery which supplies a DC voltage of 10V, and the power channel control units (120, 122, 124) are power diodes. Hence, with the power channel control units (120, 122, 124) being diodes, the multi-power supply device automatically selects the power input unit (110) to be the main power because, among the power input units (110, 112, 112), the power input unit (110) has the highest output voltage. If the power diodes have an ON voltage of 0.7V each, the power channel control units (120) each will have an output voltage of around 12.3V. Since the power channel control units (120) are turned on, the current to be output from the multi-power supply device output is supplied by the power input unit (110). However, since both the output voltage 11.3V of the power channel control unit (122) and output voltage 9.3V of the power channel control unit (124) are lower than the output voltage 12.3 V of the power channel control unit (124) and thus cannot be turned on, thereby not being able to output a current.

In an embodiment of the present invention, during a period of time which the multi-power supply device is operating, if the power input unit (110) is unplugged, the output voltage of the power channel control unit (120) will drop gradually (because a circuit load, capacitor and the like are capable of storing energy.) If the output voltage of the power channel control unit (120) drops below 12V, the voltage drop across the power channel control unit (122) exceeds 0.7V such that the power channel control unit (122) is turned on to become the main power. During the process the output voltage of the power channel control unit (120) drops gradually and the power channel control unit (122) is turned on, voltage and current are always continuous, and a balance is automatically struck between the powers in terms of voltage in the same way as water pressure communication pipes work, and in consequence the conversion process is free of surges or interference which might otherwise be caused by electronic switching.

The power input unit (110) will restore its power supply after a power outage to become the main power again, if the output voltage of the power channel control unit (120) exceeds the input power (i.e., input voltage) of the power input units (112, 112).

Two or all of the power channel control units (120, 122, 124) are equal in output voltage, and thus the multi-power supply device automatically strikes a balance between the three powers, with the output voltage being the balanced voltage. For instance, the input voltage of the power input unit (114) is adjusted to increase from 10V gradually. When the input voltage of the power input unit (114) increases to a level that equals the output voltage of the AC-to-DC conversion unit (210), both the power channel control unit (120) and the power channel control unit (124) are turned on to each supply some current to the power output unit 130.

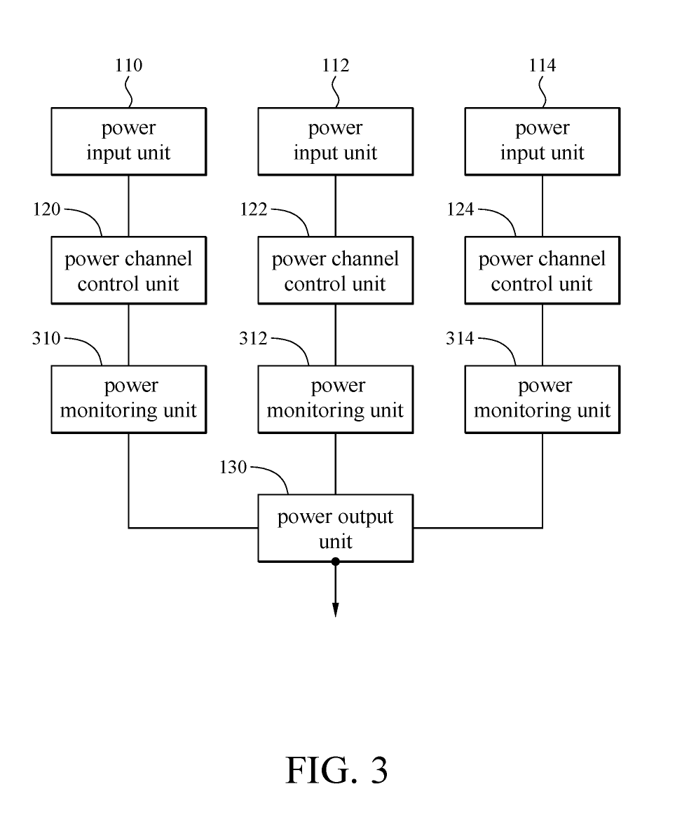

Referring to FIG. 3, there is shown a schematic view of the multi-power supply device capable of power monitoring according to an embodiment of the present invention. In an embodiment of the present invention, the multi-power supply device further comprises a plurality of power monitoring units (310, 312, 314) electrically connected between the power output unit 130 and the power channel control units (120, 122, 124) to monitor voltage and current and send a monitoring signal.

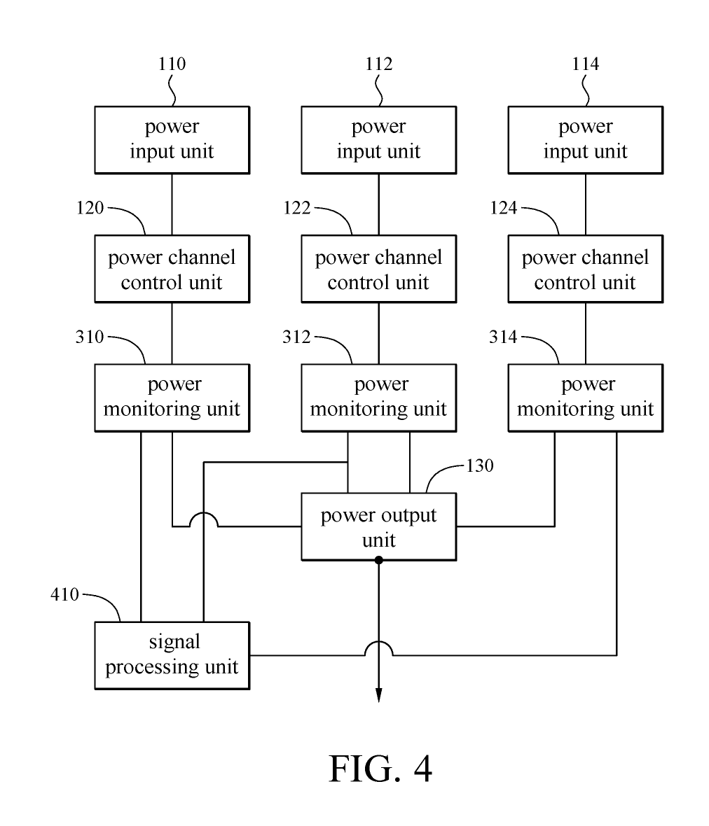

Referring to FIG. 4, there is shown a schematic view of the multi-power supply device capable of signal processing according to an embodiment of the present invention. In an embodiment of the present invention, the multi-power supply device further comprises a signal processing unit (410) electrically connected to the power monitoring units (310, 312, 314) to receive the monitoring signal from the power monitoring units (310, 312, 314) and send an alert in response to a change in the monitoring signal from the power monitoring units (310, 312, 314). The power monitoring units (310, 312, 314) comprise a current sensing chip and a voltage detecting loop. In an embodiment of the present invention, if the input power of the power input unit (110) with the highest output voltage vanishes, the signal processing unit (410) will send a message to inform users of this and automatically switch to a power of the second highest voltage, thereby allowing the system to continue with its operation.

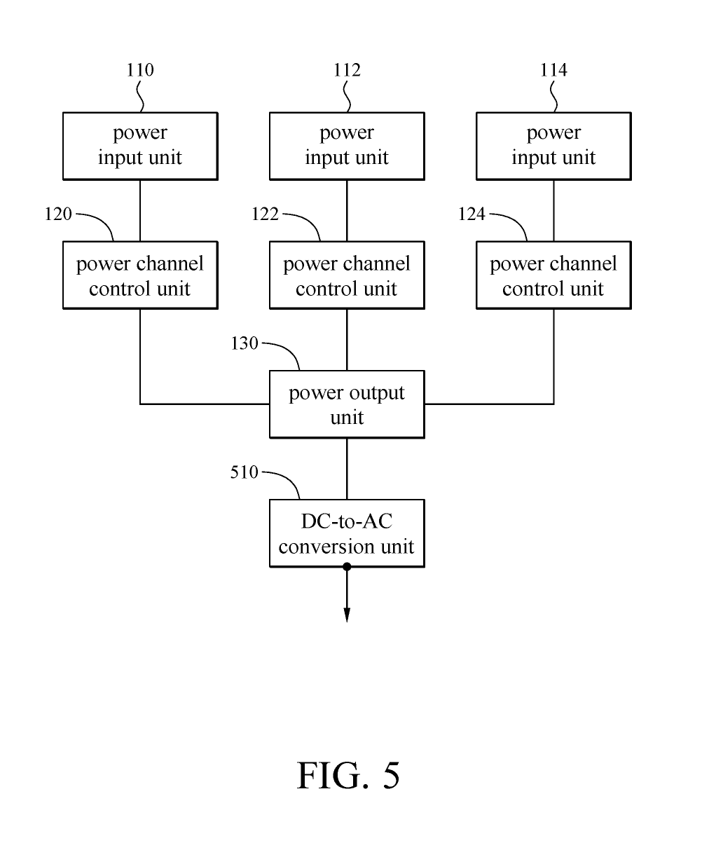

Referring to FIG. 5, there is shown a schematic view of the multi-power supply device capable of DC to AC conversion according to an embodiment of the present invention. In an embodiment of the present invention, the multi-power supply device further comprises a DC-to-AC conversion unit (510) which is electrically connected to the power output unit (130) and adapted to convert the DC power output of the power output unit (130) into AC power output.

The above embodiments are illustrative of the features and effects of the present invention rather than restrictive of the scope of the substantial technical disclosure of the present invention. Persons skilled in the art may modify and alter the above embodiments without departing from the spirit and scope of the present invention. Therefore, the scope of the protection of rights of the present invention should be defined by the appended claims.

What is claimed is:

1. A multi-power supply device, comprising:
a plurality of power input units configured to each supply an input power and being one of DC power input units, AC power input units, and a combination thereof;
a plurality of power channel control units electrically connected to the power input units, respectively, and turned on as soon as an output end voltage of the power channel control units is lower than an input end voltage of the power channel control units, wherein the power channel control unit of a highest input voltage is turned on to generate an ON voltage; and
a power output unit electrically connected to the power channel control units and adapted to output the ON voltage.

2. The multi-power supply device of claim 1, further comprising an AC-to-DC conversion unit electrically connected between each said AC power input unit and a corresponding one of the power channel control units to convert AC power output from the AC-to-DC conversion unit into DC power.

3. The multi-power supply device of claim 1, wherein the power input units comprise at least a DC power input unit and at least an AC power input unit.

4. The multi-power supply device of claim 3, further comprising an AC-to-DC conversion unit electrically connected between each said AC power input unit and a corresponding one of the power channel control units to convert AC power output from the AC-to-DC conversion unit into DC power.

5. The multi-power supply device of claim 1, wherein the power channel control units are power diodes.

6. The multi-power supply device of claim 1, further comprising power monitoring units electrically connected between the power channel control units and the power output unit, respectively, to monitor voltage and current and send a monitoring signal.

7. The multi-power supply device of claim 6, further comprising a signal processing unit electrically connected to the power monitoring units to receive the monitoring signal from the power monitoring units, so as to send an alert in response to a change in the monitoring signal from the power monitoring units.

8. The multi-power supply device of claim 6, wherein the power monitoring units comprise a current sensing chip and a voltage detecting loop.

9. The multi-power supply device of claim 1, further comprising a DC-to-AC conversion unit electrically connected to the power output unit to convert DC power output from the power output unit into AC power output.
